(19) United States
(12) Patent Application Publication
(10) Pub. No.: US 2014/0248857 A1
(43) Pub. Date: Sep. 4, 2014

(54) MMS message editing method and device

(71) Applicants: Lianfang Huang, Shenzhen (CN); Jiejie Liu, Shenzhen (CN); Wen Fang, Shenzhen (CN)

(72) Inventors: Lianfang Huang, Shenzhen (CN); Jiejie Liu, Shenzhen (CN); Wen Fang, Shenzhen (CN)

(73) Assignee: ZTE CORPORATION, Shenzhen, Guangdong (CN)

(21) Appl. No.: 14/349,886

(22) PCT Filed: Jan. 19, 2012
(86) PCT No.: PCT/CN2012/070622

§ 371 Date: Apr. 4, 2014

(30) Foreign Application Priority Data
Oct. 8, 2011 (CN) 201110299933.1

(51) Int. Cl. H04W 4/12; H04M 1/725

(52) U.S. Cl. CPC H04W 4/12; H04M 1/72547
USPC 455/412.1; 455/566

(57) ABSTRACT

A Multimedia Messaging Service (MMS) message editing method is disclosed, which includes that: the content of an MMS message is edited in an MMS message preview state; the information of an operation on the content of the MMS message in the preview state is converted into an operation of modifying or adding content to an original MMS file of the MMS message corresponding to Synchronized Multimedia Integration Language (SMIL), and the modification made to the SMIL file is stored. The disclosure also relates to an MMS message editing device. By means of the technical solution of the disclosure, an editing function is added in the preview of an MMS message, so that a user can stretch a media file, shrink the media file or adjust the position of the media file on an interface, or can also add a tag or draw an image on the interface, thus greatly enriching functions of an MMS message slide and improving user experience.

### TECHNICAL FIELD

The disclosure relates to Multimedia Messaging Service (MMS) message processing technology, and particularly to an MMS message editing method and device.

### BACKGROUND

An MMS message with the integration of a text, an image, audio and video is an application popularly used currently. The MMS message integrates different kinds of media files by using Synchronized Multimedia Integration Language (SMIL). Like Microsoft PowerPoint, the MMS message adds a text, an image, music and the like into each piece of slide to produce an illustrated multimedia message. The edition for the MMS message is carried out in an MMS message editor which converts an edition operation of a user into SMIL, stores the SMIL and provides a preview.

The SMIL is generally divided into two parts: Head and Body. The MMS message corresponding to the following SMIL file contains three pieces of slides: a slide of image, a slide of audio and a slide of video, in each of which text information is contained. The Head part mainly enumerates the size of a page, the elements contained in the page, and the display length, width and position of each element. The Body part mainly contains the play time of the page, an index for the elements in the page, and the corresponding display position of each element in the Head. For example, an SMIL file is as follows:

<smil>
<head>
<layout>
<root-layout width=“240” height=“400” background-color=“#ffffff”/>
<region id=“Image” width=“100%” height=“50%” left=“0%”
top=“0%” fit=“meet”/>
<region id=“Text” width=“100%” height=“50%” left=“0%”
top=“50%” fit=“scroll”/>
</layout>
<head>
<body>
<par dur=“5000ms”>
<text src=“T001.txt” region=“Text” />
<img src=“I1313510998.jpg” region=“Image” />
</par>
<par dur=“5000ms”>
<text src=“T002.txt” region=“Text” />
<video src=“160811-1610.3gp” region=“Image” />
</par>
<par dur=“5000ms”>
<text src=“T003.txt” region=“Text” />
<audio src=“081616102000.amr” />
</par>
</body>
</smil>

It can be seen from the aforementioned SMIL file that the Identifier (ID) of used resource is marked in the SMIL so that the resource corresponding to the ID can be found out with an ID and displayed according to the description in the SMIL. Om addition, attributes, including dur, begin, end, clip-begin, clip-end and the like, may also be contained in the SMIL file to describe the play attribute of a media file in more detail.

Similar to Hypertext Markup Language (HTML) used in webpages, an existing webpage is supported by the SMIL in adding a tag on a browse interface, but an existing MMS message editor is not supportive to this function. In addition, the play and the edition of the MMS message are separated at present, making it impossible for a user to make a direct adjustment on the irrational position or size of an image or video during the process of preview. The combination of the play and the edition of the MMS message, if realized, will well achieve a ‘what you see is what you get’ effect.

### SUMMARY

The disclosure aims to provide an MMS message editing method and device to solve the problem that an MMS message cannot be edited or modified at present when previewed or nothing can be manually drawn on a preview interface.

To this end, an MMS message editing method is provided, which includes: the operated content of the MMS message is described by using SMIL according to the operation of a user on the content of the MMS message; the content of the MMS message content is played by using the SMIL when the content of the MMS message needs to be previewed; and

the content of the MMS message is edited in a preview mode when the content of the MMS message is previewed, the SMIL is modified and the modified SMIL is stored.

In the method, the editing the content of the MMS message in a preview mode may include: a position, a size or duration of multimedia media element is adjusted and the content of the MMS message is drawn in the preview mode.

In the method, the adjusting a position of a media element may include:

during the process of adjusting a first media element, the user is given a prompt if coordinate points of the first media element are partially or entirely contained in the range of a second media element; the second media element is covered with the first media element if the user confirms to cover the second media element with the first media element, or the first media element is restored to its original position if the user chooses not to cover the second media element with the first media element; or

a position of the second media element and a position of the first media element are exchanged.

In the method, the adjusting a size of a media element may include:

the media element is stretched or shrunk and the media element is backed up.

In the method, the adjusting duration of a media element may include:

the duration corresponding to the media element is displayed when the MMS message enters the preview mode, and the duration of the media element is adjusted based on the starting moment and the ending moment of the media element.

In the method, the drawing the content of the MMS message in the preview mode may include:

the drawn image or tag and an original image are combined into one image, the combined image is stored in a file system and a new file Identifier (ID) is generated; or

a new element type is defined, and a tag is added and an image is drawn on the interface, wherein an ID is generated automatically by the file system and the image corresponding to the ID is stored in the file system.

In the method, the tag may include: a pen point type, a pen point color, an eraser and cancel for controlling a type and a color of the tag, which are used for controlling a type and a color of the tag.

The disclosure also discloses an MMS message editing device, which includes:

an MMS message editing module configured to describe, according to an operation of a user on content of an MMS message, the operated content of the MMS message by using SMIL, the content of the MMS message including a media element;

a preview module configured to play the MMS message by using the SMIL when the MMS message needs to be previewed; and

a preview editing module configured to edit the content of the MMS message in a preview mode when the MMS message content is previewed, modify the SMIL and store the modified SMIL.

In the device, the preview editing module may be configured to adjust a position, a size or duration of a media element and draw the content of the MMS message in the preview mode.

In the device, the preview editing module may include:

a pen point control configured to provide pen point types and pen point colors on the preview interface for the user to select calligraphy of a different thickness or color for use; and

a modification control configured to provide an eraser and cancel on the preview interface to enable the user erase or cancel the drawn content.

By means of the technical solution of the disclosure, an editing function is added in the preview of an MMS message, so that a user can stretch a media file, shrink the media file or adjust the position of the media file on an interface, or can also add a tag or draw an image on the interface, thus greatly enriching functions of an MMS message slide and improving user experience. In addition, the disclosure can achieve an expected effect only by making a little modification on a device, without changing hardware or software significantly.

### BRIEF DESCRIPTION OF THE DRAWINGS

The accompanying drawings illustrated here are intended to provide further understanding to the disclosure, and constitute a portion of the disclosure. Illustrative embodiments of the disclosure and description thereof are used to explain the disclosure instead of constituting improper restriction to the disclosure. In the accompanying drawings:

FIG. 1 is a structure diagram of a first embodiment of the disclosure;

FIG. 2 is a flowchart of a second embodiment of the disclosure;

FIG. 3 is a schematic diagram illustrating unadjusted media elements of an MMS message according to the second embodiment of the disclosure;

FIG. 4-1 and FIG. 4-2 are schematic diagrams illustrating adjustment on positions of media elements according to the second embodiment of the disclosure;

FIG. 5 is a schematic diagram illustrating adjustment on the size of a media element according to the second embodiment of the disclosure;

FIG. 6 is a schematic diagram illustrating adjustment on the duration of a media element according to the second embodiment of the disclosure; and

FIG. 7 is a schematic diagram illustrating a manually drawn image or tag according to the second embodiment of the disclosure.

### DETAILED DESCRIPTION

In order to make the technical problem to be solved, the technical solution and beneficial effects of the disclosure clearer and easier to understand, the disclosure is further elaborated below with reference to the drawings and embodiments. It should be understood that the specific embodiments described here are only intended to interpret the disclosure instead of limiting the disclosure.

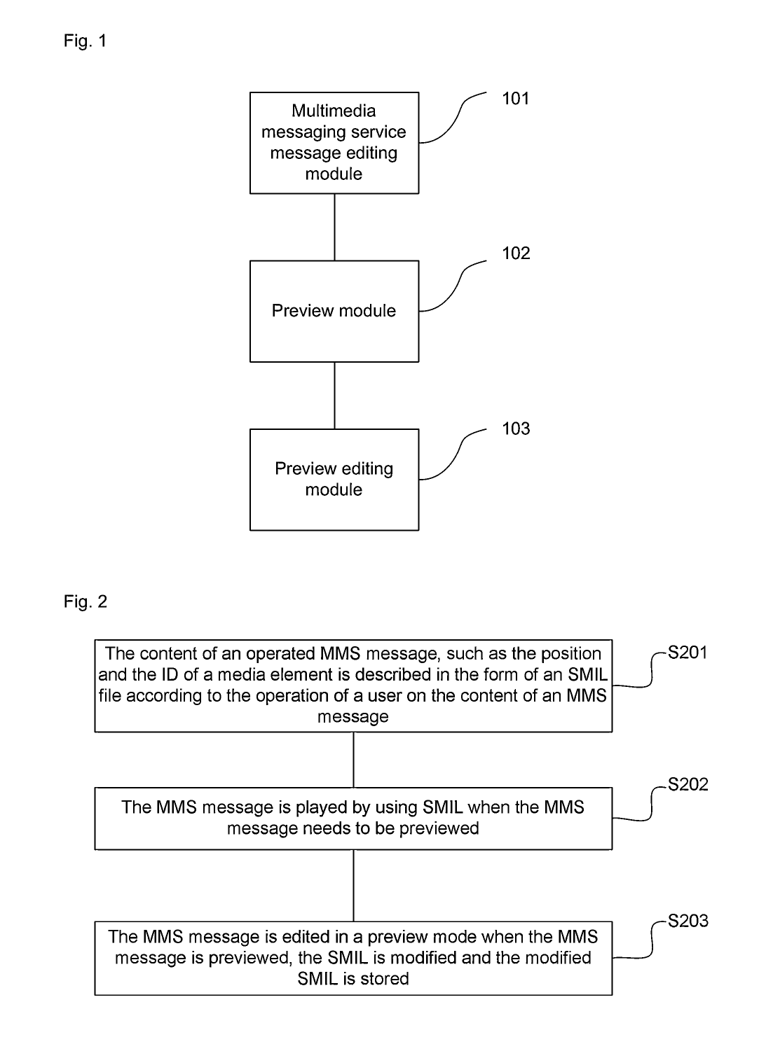

FIG. 1 is a structure diagram of a first embodiment of the disclosure. As shown in FIG. 1, an MMS message editing device disclosed herein includes:

an MMS message editing module 101 configured to describe, according to an operation of a user on the MMS message content, the operated MMS message content, such as a position of a media element and an ID of a media element, in the form of an SMIL file, wherein the MMS message content consists of media elements, and the attributes of each media element include the position, the size, the duration and the like of the media element;

a preview module 102 configured to play the MMS message by using the SMIL when the MMS message needs to be previewed; and

a preview editing module 103 configured to edit the MMS message in a preview mode when the MMS message is previewed, modify the SMIL and store the modified SMIL.

Specifically, the edition on the MMS message in a preview mode includes: an adjustment on the position, the size or the duration of a media element, and the drawing of the user;

the position of an image is adjusted by long pressing any position within the image and dragging the image to any position, and a prompt is given to the user when the image covers a text or another image;

for an audio or video, a duration progress bar is displayed on the preview interface so that the show time of the audio or video can be adjusted by dragging the starting position and the ending position of the duration progress bar; and

the edge or four corners of an image can be dragged to adjust, for example, stretch or shrink, the size of the image.

After the user confirms and stores the modification made in the preview mode, the cell phone of the user searches for corresponding resource information from the SMIL file according to the modified ID of the media element, and changes attribute values of the original SMIL file according to the current position, size, duration or the like of the SMIL file.

In a full-screen preview state of the MMS message, the user is allowed to manually draw or delineate content, for example, delineating or punctuating the key content of a slide.

The preview editing module further includes:

a pen point control configured to provide pen point types and pen point colors on the preview interface for the user to select the calligraphy of a different thickness or color for use; and

a modification control configured to provide an eraser and cancel on the preview interface to enable the user to erase or cancel the drawn content.

After the user confirms and stores the modification made in the preview mode, the position of the drawn image is read, and the ID and corresponding attributes of the newly-added image are added in the original SMIL file.

FIG. 2 is a flowchart of a second embodiment of the disclosure. As shown in FIG. 2, an MMS message editing method disclosed herein includes:

Step S201: The content of an operated MMS message, such as the position and the ID of a media element is described in the form of an SMIL file according to the operation of a user on the content of an MMS message. The content of the MMS message includes media elements, and specifically includes the page information of the MMS message, the multimedia information of the page and the layout information of the page.

Step S202: The MMS message is played by using SMIL when the MMS message needs to be previewed; and

Step S203: The MMS message is edited in a preview mode when the MMS message is previewed, the SMIL is modified and the modified SMIL is stored.

The editing the MMS message in the preview mode includes the adjustment on the position, the size or the duration of a media element and the drawing of the user.

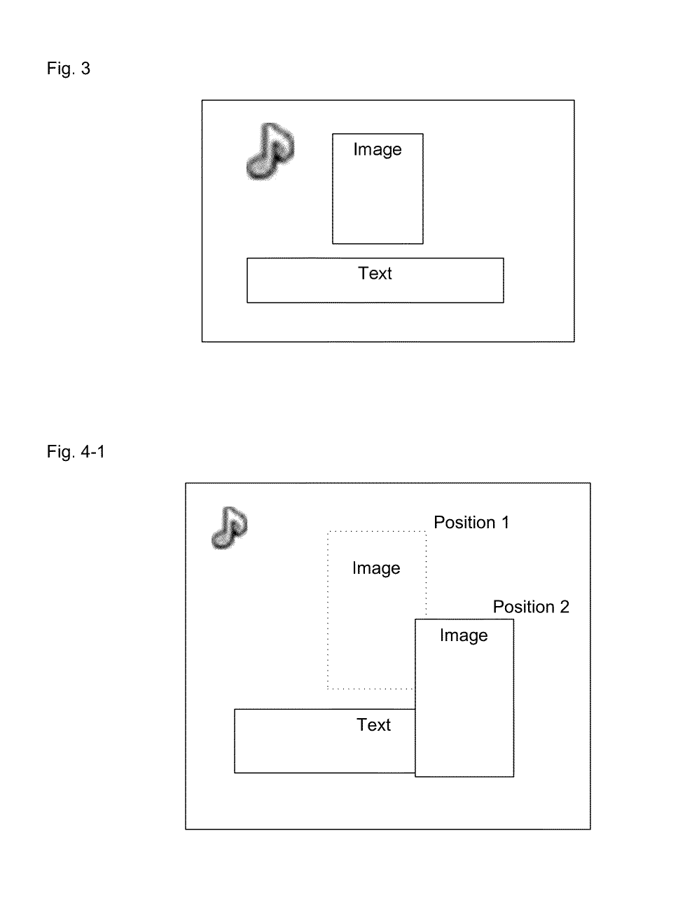

Specifically, FIG. 3 is a schematic diagram illustrating unadjusted media elements of an MMS message according to the second embodiment of the disclosure. The MMS message includes an audio file, an image and text information, and the MMS message is played in a format preset by a terminal.

FIG. 4-1 and FIG. 4-2 are schematic diagrams illustrating adjustment on positions of media elements according to the second embodiment of the disclosure, including scenario 1 and scenario 2.

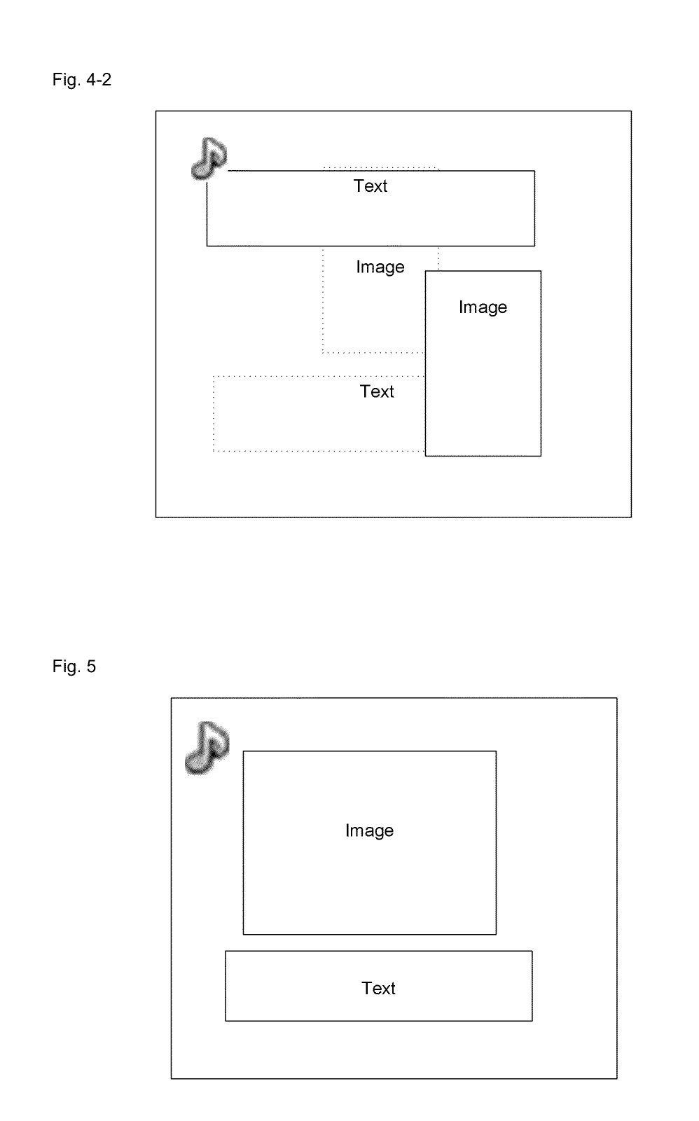

Scenario 1: As shown in FIG. 4-1, the image is long pressed to be dragged from position 1 to position 2. If the image covers the text during the drag process, that is, if coordinate points of the image are partially or entirely contained in the range of text information, a prompt is given to the user. If the user confirms the coverage, the image covers the text. If the user chooses not to cover the text, the image is restored to its original position or the interface is changed to the interface shown in scenario 2.

After the position of the multimedia element in the MMS message is modified, the user stores the modified MMS message, and then the SMIL file of the MMS message is updated. By taking the SMIL file mentioned in the BACKGROUND as an example, the layout in the SMIL file in scenario 1 is modified as follows:

<layout>
<root-layout width=“240” height=“400” background-color=“#ffffff”/>
<region id=“Image” width=“100%” height=“50%” left=“25%”
top=“25%” fit=“meet”/>
<region id=“Text” width=“100%” height=“50%” left=“0%”
top=“50%” fit=“scroll”/>
</layout>

Scenario 2: as shown in FIG. 4-2, after the position of the image is modified, the text information in the slide is exchanged in position with the original image according to the residual space condition of the page.

To facilitate understanding, still taking the SMIL file mentioned in the BACKGROUND as an example, the layout in the SMIL file is as follows:

<layout>
<root-layout width=“240” height=“400” background-color=“#ffffff”/>
<region id=“Image” width=“100%” height=“50%” left=“0%”
top=“0%” fit=“meet”/>
<region id=“Text” width=“100%” height=“50%” left=“0%”
top=“50%” fit=“scroll”/>
</layout>

It can be seen that the coordinates of the top left corner of the image are (0, 0), the size of the image is (120*120) (the original size of the image is 240*240, as fit is equal to meet, the original size of the image is scaled to half of the original size of the image according to the size of the page), and the coordinates of the top left corner of text information are (0, 200). The image is dragged to the coordinate point (60, 100) to partially cover the text information. The terminal prompts the user whether to cover the text information. If the user selects ‘Yes’, then the text and the image are displayed in an overlapped manner. If the user selects ‘No’, then the image is restored to the initial position or is moved to a new position, and the position of the text is changed. As shown in scenario 2, the position of the text information and the position of the image are exchanged.

FIG. 5 is a schematic diagram illustrating the adjustment on the size of a media element according to the second embodiment of the disclosure. As shown in FIG. 5, the adjustment includes:

dragging the edge or four corners of the image to stretch or shrink the size of the image.

Still taking the SMIL file mentioned in the Background as an example, the original width of the image is dragged to be doubled, thus the size of the image is changed from the original 120*200 to 240*200. At this moment, the layout of the original SMIL file is modified as follows:

<layout>
<root-layout width=“240” height=“400” background-color=“#ffffff”/>
<region id=“Image” width=“100%” height=“50%” left=“0%”
top=“0%” fit=“hidden”/>
<region id=“Text” width=“100%” height=“50%” left=“0%”
top=“50%” fit=“scroll”/>
</layout>

Since the previous attribute of the image is ‘meet’, which indicates a scale-up or scale-down change, it is not applicable to the stretch or shrink of the image in the embodiment. Thus, in this operation, the Image attribute in the SMIL file is modified to be hidden after the image is changed in size. Hidden indicates that a multimedia clip is kept unchanged in the size, and the multimedia clip is started to be displayed from the top left corner of the window. The margin part of the window is filled with the background color if the multimedia clip is smaller in size than the window. If the part of the multimedia clip beyond the window is cut off and not displayed if the multimedia clip is larger in size than the window.

Here, as the image is changed in size, it is needed to back up the original image. The size of the backed-up image is the modified size (here being 240*200), and the ID corresponding to the SMIL file is modified to be the modified ID (e.g., I1313510998(1)). The image-related modification in the Body part of the original SMIL file is as follows:

<img src=“I1313510998(1).jpg” region=“Image” />

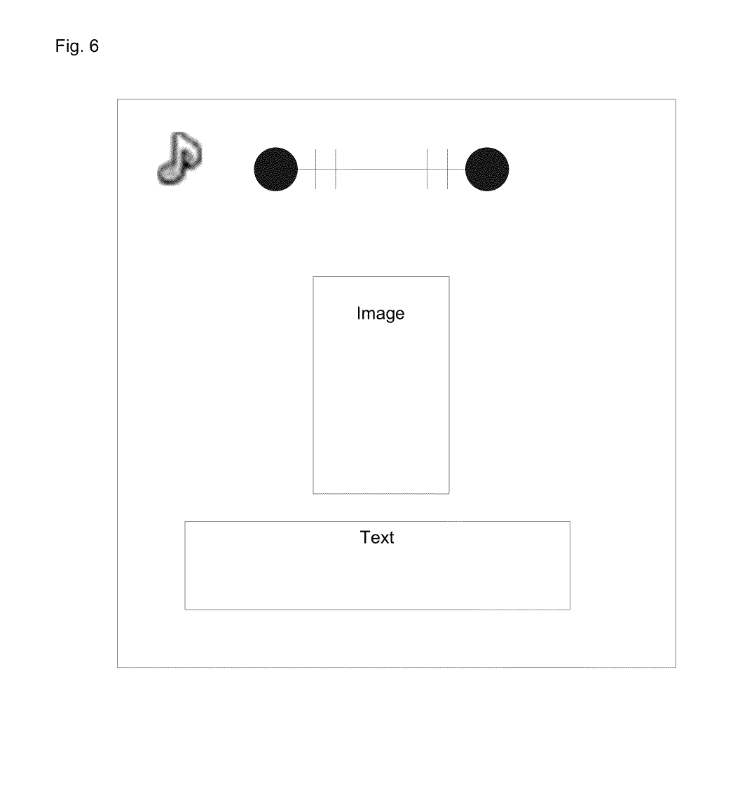

FIG. 6 is a schematic diagram illustrating the adjustment on the duration of a media element according to the second embodiment of the disclosure. As shown in FIG. 6, the adjustment includes:

a corresponding duration of a multimedia audio is displayed when an MMS message enters into an editing mode. The user may adjust the duration of the audio of the MMS message by adjusting the starting moment and the ending moment of the audio. If the duration of the audio is from 2 s to 4 s, then the audio-related attributes in SMIL are modified as follows:

<audio src=“081616102000.amr”, clip-begin=“2000ms”
clip-end=“4000ms” />

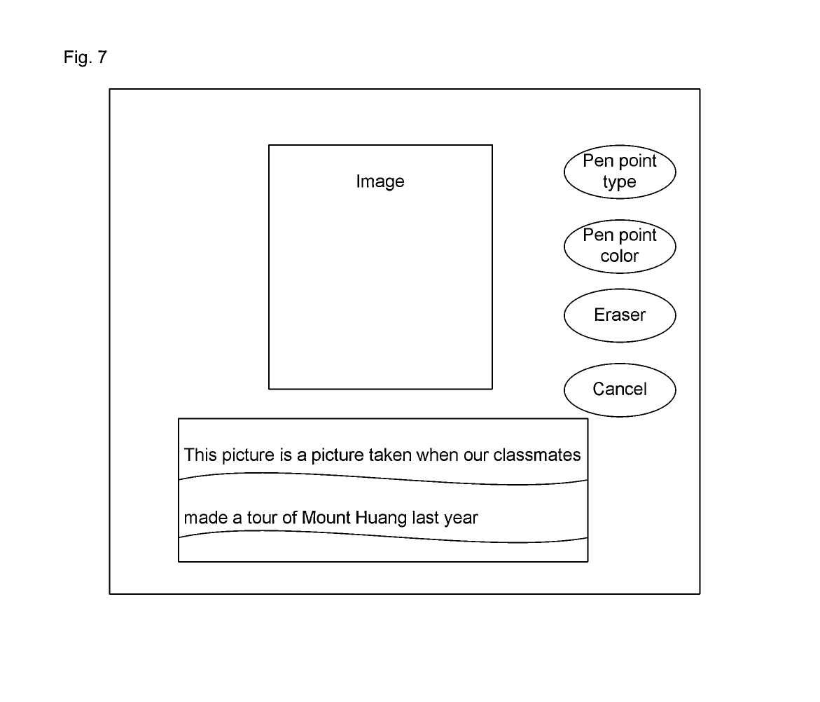

FIG. 7 is a schematic diagram illustrating a manually drawn image or tag according to the second embodiment of the disclosure. As shown in FIG. 7, the drawing is achieved in the following ways:

Way 1: The drawn image or tag and an original image are combined into one image, the combined image is stored in a file system and a new file ID is generated. By taking the SMIL file mentioned in the BACKGROUND as an example, it is assumed that a new image ID is Image_new, then the Head part is modified as follows:

<head>
<layout>
<root-layout width=“240” height=“400” background-color=“#ffffff”/>
<region id=“Image” width=“100%” height=“100%” left=“0%”
top=“0%” fit=“hidden”/>
<region id=“Text” width=“100%” height=“50%” left=“0%”
top=“50%” fit=“scroll”/>
</layout>
<head>

Here, the height is modified to be 100% so that the image can cover the full screen, and the fit is selected to be Hidden so that the image can be displayed in the original size.

Here, the Body part is modified to replace the original name with Image_New.

<img src=“Image_new.jpg” region=“Image” />

Way 2: A new element type is defined, for example, the element type is set as ‘Mark’, a tag is added and an image is drawn on an interface, a corresponding resource ID and related attributes are added in the original SMIF file, wherein the resource ID is automatically generated by a system, and a corresponding image is stored in the file system.

Two horizontal lines shown in FIG. 7 can be considered to be two Marks, and two images are named as mark1 and mark2. Then, in the original SMIL file, two new lines of content are added in the Head part:

<head>
<layout>
<root-layout width=“240” height=“400” background-color=“#ffffff”/>
<region id=“Image” width=“100%” height=“50%” left=“0%”
top=“0%” fit=“meet”/>
<region id=“Text” width=“100%” height=“50%” left=“0%”
top=“50%” fit=“scroll”/>
<region id=“Mark1” width=“100%” height=“50%” left=“0%”
top=“60%” fit=“hidden”/>
<region id=“Mark2” width=“100%” height=“50%” left=“0%”
top=“80%” fit=“hidden”/>
</layout>
<head>

The Body part is added with the following contents:

<body>
<par dur=“5000ms”>
<text src=“T001.txt” region=“Text” />
<img src=“I1313510998.jpg” region=“Image” />
<img src=“mark1.jpg” region=“Mark1” />
<img src=“ mark1.jpg” region=“ Mark 2” />
</par>

In addition, spaces for ‘a pen point type ’, ‘a pen point color ’, ‘eraser’ and ‘cancel’ are added on a tag interface to control the type and the color of a tag.

The foregoing description illustrates and describes the preferred embodiment of the disclosure. However, as previously mentioned, it should be understood that the disclosure is not restricted to the form disclosed by the present document and should not be regarded as exclusion of other embodiments, but can be used to various other combinations, modifications and environments and can be modified according to the above teaching or technologies or knowledge of related fields within the scope of conception of the disclosure described in the present document. Furthermore, modifications and changes made by those skilled in the art without departing from the spirit and principle of the disclosure shall fall within the scope of protection of the claims of the disclosure.

1. A Multimedia Messaging Service (MMS) message editing method, comprising:
describing, according to an operation of a user on content of an MMS message, the operated content of the MMS message by using Synchronized Multimedia Integration Language (SMIL); and playing the content of the MMS message by using the SMIL when the content of the MMS message needs to be previewed; and
editing the content of the MMS message in a preview mode when the content of the MMS message is previewed, modifying the SMIL and storing the modified SMIL.

2. The method according to claim 1, wherein the editing the content of the MMS message in a preview mode comprises: adjusting a position, a size or duration of a media element and drawing the content of the MMS message in the preview mode.

3. The method according to claim 2, wherein the adjusting a position of a media element comprises:
during the process of adjusting a first media element, giving the user a prompt if coordinate points of the first media element are partially or entirely contained in a range of a second media element; covering the second media element with the first media element if the user confirms to cover the second media element with the first media element, or restoring the first media element to its original position if the user chooses not to cover the second media element with the first media element; or
exchanging a position of the second media element and a position of the first media element.

4. The method according to claim 2, wherein the adjusting a size of a media element comprises:
stretching or shrinking the media element, and backing up the media element.

5. The method according to claim 2, wherein the adjusting duration of a media element comprises:
displaying the duration corresponding to the media element when the MMS message enters the preview mode, and adjusting the duration of the media element based on a starting moment and an ending moment of the media element.

6. The method according to claim 2, wherein the drawing the content of the MMS message comprises:
combining the drawn image or tag and an original image into one image, storing the combined image in a file system and generating a new file Identifier (ID); or
defining a new element type, adding a tag and drawing an image on an interface, wherein an ID is generated automatically by the file system and the image corresponding to the ID is stored in the file system.

7. The method according to claim 6, wherein
the tag includes: a pen point type, a pen point color, an eraser and cancel, which are used for controlling a type and a color of the tag.

8. A Multimedia Messaging Service (MMS) message editing device, comprising:
an MMS message editing module configured to describe, according to an operation of a user on content of an MMS message, the operated content of the MMS message by using Synchronized Multimedia Integration Language (SMIL), the content of the MMS message including a media element;
a preview module configured to play the MMS message by using the SMIL when the MMS message needs to be previewed; and
a preview editing module configured to edit the content of the MMS message in a preview mode when the MMS message is previewed, modify the SMIL and store the modified SMIL.

9. The device according to claim 8, wherein the preview editing module is configured to adjust a position, a size or duration of a media element and draw the content of the MMS message in the preview mode.

10. The device according to claim 9, wherein the preview editing module comprises:
a pen point control configured to provide pen point types and pen point colors on a preview interface for the user to select calligraphy of a different thickness or color; and
a modification control configured to provide an eraser and cancel on the preview interface to enable the user to erase or cancel the drawn content.
